(19) United States
(12) Patent Application Publication
(10) Pub. No.: US 2007/0024173 A1
(43) Pub. Date: Feb. 1, 2007

(54) Luminophore-Based Led and Corresponding Luminous Substance

(76) Inventor: Bert Braune, Wenzenbach (DE)

Correspondence Address: Thomas Langer;Cohen Pontani Lieberman & Pavane, Suite 1210, 551 Fifth Avenue, New York, NY, 10176, US

(21) Appl. No.: 10/552,936

(22) PCT Filed: Apr. 6, 2004
(86) PCT No.: PCT/DE04/00722

§ 371 Date: Oct. 11, 2005

(30) Foreign Application Priority Data
Apr. 10, 2003 (DE) 103 16 769.2

(51) Int. Cl. H05B 33/00

(52) U.S. Cl. 313/485; 313/486; 313/501

(57) ABSTRACT

An LED with inorganic phosphor, an LED chip emitting primary radiation in the range of 300 to 470 nm, this radiation being converted partly or completely into longer-wave radiation by at least one phosphor which is exposed to the primary radiation of the LED, the conversion being achieved at least with the assistance of a phosphor of a mean particle size d50 that lies in the range of 1 to 50 nm, preferably 2 to 25 nm.

### TECHNICAL FIELD

The invention relates to a phosphor-based LED and associated phosphor according to the precharacterizing clause of claim 1. It concerns in particular white or colored luminescence-conversion LEDs with blue or UV emitting primary radiators. The term LED is intended here always to mean LEDs with inorganic phosphors.

### PRIOR ART

WO 02/089175 already discloses a phosphor-based LED and associated phosphor, in the case of which the UV radiation of the primary emitting source is converted by a phosphor. In order reliably to prevent the escape of UV radiation from the LED, a highly UV-scattering material, which however must not have conversion properties, is additionally used. To achieve this property, it is not so much the material that matters as that the particle size of the UV-scattering material is as small as possible and its diameter is in the range of a few nanometers. In this case, an additional material (diffuser) is consequently required in addition to the phosphor in the resin. Halo and penumbra effects are also avoided in this way.

A quite similar LED system, but entirely without phosphor, is described generally for the reduction of scattering losses (Fresnel losses) of the emitting light source in U.S. Pat. No. 5,777,433.

EP 1 074 603 describes the production of an oxidic phosphor with a particle size in the nanometer range. The field of LEDs or OLEDs is specified for example as the field of application.

U.S. Pat. No. 6,207,229 describes a luminescent semiconductor crystal of the CdX type, where X=S, Se, Te, for use in LEDs. It is provided with a coating of the ZnY type, where Y=S, Se. A LED using a layer of Cds of nanoparticle size is known from GB-A 2 389 230.

### SUMMARY OF THE INVENTION

It is the object of the present invention to provide a phosphor-based LED according to the precharacterizing clause of claim 1 which is distinguished by higher efficiency and uniformity of the light radiation.

This object is achieved by the characterizing features of claim 1. Particularly advantageous refinements can be found in the dependent claims.

The phosphors previously used in LUCOLEDs have particle sizes of >1 μm. The light emitted by the primary LED is not completely absorbed by the phosphor particles, but partly reflected. Single or multiple reflections cause the exciting light of the primary LED to fall partly on the chip or the housing and to be absorbed, not radiated. This means that the reflection at the phosphor particles leads to a loss of light. The first problem is to reduce the loss of light caused by reflection. The same applies, albeit to a reduced extent, to the light emitted by the phosphor particles. This also leads to losses. Even in the case of the phosphors with good absorption that are used today, which reflect only little, these losses are currently of the order of magnitude of 30%.

If the absorption of a phosphor is low and its reflection high, these multiple reflections have the effect that, even if the phosphor concentration is increased to an extreme extent, the exciting light of the primary LED is absorbed only little by the phosphor but instead is for the most part lost without being radiated, or is emitted past the phosphor. In this case, the losses caused by the reflections are so great that such phosphors cannot be used today, even if their quantum yields are very high.

In the case of the blue primary LED, the LUCOLED with extremely small phosphor concentrations always has approximately the blue color of the primary LED. In the case of a phosphor with good absorption and low reflection, it is possible by increasing the concentration of the phosphor to suppress the radiation of the blue primary LED to a great extent, so that the LUCOLED has approximately the color of the phosphor emission. In the case of phosphors with low absorption, the color shift only remains small, even in the case of an extremely high phosphor concentration. The color range that can be covered by phosphors with low absorption is consequently much too small.

It applies in general that, the greater the reflection of the phosphors, the higher the brightness losses and the lower the color range that can be set for a LUCOLED.

In the case of UV-primary LEDs, the reflection of the UV radiation from the phosphor particles to the housing increases the aging of the housing, which is today one of the greatest barriers to the introduction of UV-LEDs.

An additional problem so far has been the sedimentation of phosphors in the resin, which leads to inhomogeneities in the phosphor distribution and to great variations in the phosphor distribution in the resin from LED to LED. This leads to production problems and also to an angle-dependent color of the LUCOLED.

The sedimentation problem has so far been solved by small particle sizes of the phosphor of typically several micrometers (μm) (EP 907 969). To reduce the angle dependence of the color of the LUCOLEDs, it has been proposed to distribute the phosphor in a conformal manner directly around the chip (U.S. Pat. No. 6,351,069).

The solution to both problems lies in the use of nanoscale phosphors. In the case of particle sizes in the range of about 0.2 to 0.5 μm, the scattering of the phosphor particles is at a maximum. If the particle sizes fall further, the scattering becomes less again, until in the case of particle sizes of approximately 20 nm and less the scattering is negligible. This is evident for example from the fact that suspensions with these phosphors are clear and perfectly transparent. Therefore, particle sizes in the range of 1 to 50 nm are suitable. The object is accordingly achieved by a so-called luminescence-conversion LED (LUCOLED), the LED emitting primary radiation in the range of 300 to 470 nm, this radiation being converted partly or completely into longer-wave radiation by at least one phosphor which is exposed to the primary radiation of the LED. A decisive point is that the conversion is achieved at least with the assistance of a phosphor of a mean particle size d50 that lies in the range of 1 to 50 nm, preferably 2 to 20 nm.

The LUCOLEDs mentioned here are diodes which emit primary radiation when a low voltage of typically 1 to 5 V is applied. In this case a phosphor containing layer is applied over the chip proper that is connected to two electrodes. In addition to the phosphor particles, this layer comprises an insulating polymer. Because of is photoluminescent property, the phosphor converts at least partially the radiation emitted by the chip into radiation that has a greater wavelength than the primary radiation of the chip.

In contrast to this, known nanoparticle LEDs such as may be found in the prior art are of entirely different construction. The abbreviation LED stands here really for light emitting device, although it is wrongly understood by some to mean light emitting diode. Such a device, however, is not really a diode but an electroluminescent device (abbreviation ELD (electro-luminescent device) in English). It is typical for an electroluminescent device that the phosphor is arranged as a thin layer between two electrodes and is embedded in a conductive polymer which then provides for conduction to the phosphor. A relatively high voltage of at least 20 V is applied to the two electrodes. The requirements placed on phosphors for such devices cannot be compared to the requirements placed on phosphors for LUCOLEDs.

The following advantages can be achieved in the case of LUCOLEDs by reducing the scattering with nanoscale phosphors:
Increasing the brightness of today's LEDs by up to 30% by reduction/avoidance of reflection losses.
Possibility of using many phosphors which have only low absorption but high quantum yields.
Extension of the color range that can be set by means of the concentration of the phosphors.
Reduction of the undesired short-wave radiation, so that only a small residual amount leaves the area of the conversion: this aspect is advantageous in two respects: (1) housing aging, in particular in the case of UV-LEDs, is drastically reduced; (2) no short-wave radiation that is harmful to the human organism (above all UV) is emitted any longer from the surface of the LED.

Especially suitable systems use an LED emitting primary UV radiation (peak wavelength in the range of 330 to 410 nm) together with an RGB system. Suitable for example as the phosphor component is SCAP:Eu for emission in the blue spectral range, red emitting nitrides for the red spectral range and strontium-aluminate phosphors for the green spectral range. A series of suitable phosphor systems is compiled below.
1. SCAP:Eu (blue)
2. SCAP:Eu,Mn (blue, blue-green, green, white)
3. SrMgAl10O17:Eu (SAE, blue)
4. BAM:Eu (blue) and BAM:Eu, Mn (blue, blue-green, white)
5. Sr-aluminates:Eu and Sr-aluminates:Eu,Mn. To be specific, SrAl2O4, Sr4Al14O25. All with Eu and Eu,Mn version, all possibly additionally with partial Ba, Ca substitution for Sr (all blue, blue-green, green)
6. Sr2SiO4:Eu also with partial Ba, Ca substitution for Sr. This phosphor works particularly well for UV-LEDs (green, yellow, orange)
7. YBO3:Ce,Tb (green), generally Ln=La,Gd for Y or mixtures thereof
8. Y2SiO5:Ce,Tb (green), generally Ln=La,Gd for Y or mixtures thereof
9. ZnS:Ag (blue), ZnS:Cu, ZnS:Cu,Al (green) if necessary CdZnS:Cu,Al; furthermore, ZnS:Cu,Mn is a green alternative to ZnS:Cu,Al and ZnS:Cu
10. Y2O2S:Eu generally Ln2O2S:Eu where Ln=La,Gd for Y or mixtures thereof (red). Also with co-doping of Bi.
11. SrS:Eu-(red)
12. red emitting nitrides.

Further special embodiments are phosphors in which, depending on the excitation wavelength of the LED and absorption spectrum of the phosphor, the peak wavelength of the UV emitting LED lies in the vicinity of the absorption edge of the phosphors and which therefore do not greatly absorb the exciting radiation of the UV-LED. Today this is the case with very many phosphors, since UV-primary LEDs that are as long-wave as possible are used, in the emission range of which many phosphors just begin to absorb. Examples are the aforementioned phosphors 1, 2, 4, 5, 7 and 10 from the above list.

A further special embodiment is a yellow emitting phosphor (“Y”) in combination with a blue emitting LED (“B”). The yellow emitting phosphor is to be understood here as also meaning such systems in which at least 90% of the radiation components in the phosphor-induced emission originate from the main converter and the rest from additional converters, which merely serve the purpose of optimizing the chromaticity point.

Actual examples of a BY system are blue InGaN chips together with one of the following phosphors as the main component
1. YAG:Ce and other garnets;
2. Sr2SiO4:Eu, as explained above.
3. semiconducting nano materials.

A further preferred embodiment is a doped phosphor, which although exhibiting high absorption when there is a high concentration of the doping by an activator, can also be made to have a lower absorption by setting a considerably reduced concentration of the activator. In general, this can be achieved by an activator concentration which lies in the range from 1 to 50% of the customary activator concentration previously used in the case of phosphors for LEDs, in particular white LEDs. An actual exemplary embodiment is the group of rare-earth garnets, which are often used in the case of LEDs. Their high absorption previously had the effect that chromaticity points could not be achieved in the vicinity of the chromaticity point of the pure phosphor. For example, nano-YAG:Ce or nano-TbAG:Ce may be used. The customary Ce concentration here is 1 to 5 mol % of the rare-earth component. With nano technology, concentrations down to approximately 0.1 to 1 mol % can also be used. In the case of coarse-grained phosphor (μm range), the high scattering reduces the efficiency. An actual advantage of these low-doped garnets—in particular rare-earth garnets, above all of Y, Gd, Lu, La, Tb and their mixtures as cation A and Al and Ga or their mixtures as oxygen partner B in the formula AxByOz, above all A3B5O12,—when used in LEDs is that it is now possible for the first time for chromaticity points lying in the green spectral range to be attained. An actual example is YAG:Ce with a low Cer concentration below 1 mol %, which has the effect that the maximum emission of the phosphor (peak) shifts toward short-wave wavelengths. The coarse-grained (“μm”) variant of this phosphor containing little Ce cannot be used for LEDs because of low absorption, high scattering and the associated radiation losses; only the nano variant is advisable. So, the nano variants have the tendency here to be suitable for shifting the chromaticity point from red in the direction of green, the determinant parameters being the activator concentration (usually Ce alone or in combination with other rare earths such as Pr) and the particle size of the phosphor. A similar situation also applies to other rare-earth-doped phosphors, for example silicate and nitride phosphors.

One particular variant is the addition of host lattice components (component B of the aluminate or garnet), which likewise lead to a shifting of the emission toward short wavelengths, that is into the green range. In this case, the activator concentration may lie in the customary, previously known range. An actual example is the addition of Ga, in particular 5 to about 40 mol % of the aluminum lattice site) to the customary YAG:Ce (activator concentration 1 to 4 mol % of the component A, that is yttrium here), with the result of reducing the spectral overlap of the absorption band of the Ga-substituted YAG:Ce with the exciting 460 nm radiation of the blue LED, and consequently the absorption. In this case, too, for example only the nano version of the phosphor can be used for LEDs, in particular white LEDs, with blue primary radiation, range 430 to 470 nm.

A further preferred embodiment is that of semiconducting nanoparticles, such as for example ZnS and ZnSe. Previously, however, only the undoped and the Mn-doped phosphors have been produced at all as nanoparticles. However, this previously known doping, just with Mn, for nanoparticles is intended for entirely different purposes, see EP 622 439. Known dopings for macroscopic particles (in the μm range) are, inter alia, Al, Cu, Ag, Mn. It is proposed here for the first time to use such nanoparticles that are doped with Mn, Al, Ag and/or Cu for LEDs, in particular white LEDs, preferably with blue or UV primary radiation in the range of 300 to 470 nm. These nanoparticles can be specifically set to an absorption in the blue and UV ranges, depending on the particle size and doping. Generally, semiconductors of the II-VI type, such as (Cd, Zn) (Se, Te, S) are suitable. This type of phosphor, above all CdSe, is a highly efficient alternative to the customary yellow emitting YAG:Ce or TbAG:Ce. An alternative is a III-IV semiconductor. The particular advantage of semiconducting nanophosphors is that they have a narrow-band emission with a full width at half maximum (FWHM) of typically 30 nm.

The absorption in the case of undoped semiconducting nanophosphors commences approximately at the band edge; it is consequently separated from the emission only by a small Stokes'shift. In the case of a multi-component phosphor system, however, normally the red phosphor greatly absorbs the emission of the green phosphor, etc. To avoid this mutual absorption of the semiconductor nanophosphors, preferred therefore are phosphor systems in which either only a single undoped nano-semiconductor-phosphor is used in combination with the exciting LED or, if a number of nanophosphors are used, only the short-wave emitting one is an undoped semiconducting nanophosphor. This consideration also applies in an equivalent manner to those combinations of exciting LED primary radiation and doped semiconducting nanophosphors if the absorption of the LED radiation does not take place via the activator but in the host lattice in the case of energies greater than the band gap of the semiconductor material.

An example of a single-component system is a blue to green emitting primary radiation of the LED (430 to 480 nm), which is combined with a yellow to orange-red emitting nanophosphor of low full width at half maximum, in particular CdSe.

Usually, the phosphor is dispersed in an encapsulating compound which is exposed to the primary radiation. The encapsulating compound is preferably epoxy resin or silicone or some other similar encapsulating agent.

Other media into which the nanoscale phosphor can be introduced are: resin, air, liquids with a high refractive index (similar to in the case of eyepieces of microscopes), zeolites or other nanoporous media, plastics, glass. A particularly preferred, elegant method is to make the surface of the semiconductor chip nanoporous by etching and to introduce the nanophosphors into the porosities.

To define the terms “transparent” and “reduced scattering”, the material composite comprising nanophosphor(s) and a non-absorbing medium is considered, the “nanophosphor material”. For such a nanophosphor material, the directed transmission at an angle of incidence of less than 10° and a wavelength at which the nanophosphor, and consequently the nanophosphor material, only have neglible absorption is greater than 80%. A suitable wavelength for this test is, for example, 10 nm longer than that wavelength on the long-wave side of the emission band of the phosphor at which the emission has fallen to 1% of the maximum value.

The production of nanophosphors preferably takes place by means of CVR/CVD directly onto the chip. Garnets such as YAG are especially suitable in particular for this type of application. Suitable above all for this purpose is the principle of “wafer-level coating” with nanophosphors. In this case it is possible to apply the phosphor layer directly to the chip (for example compatible with ink jet, CVD and the like). The nanophosphors are very well suited for so-called wafer-level coating, since spin-on methods can be used. In the case of particle-filled coating compounds, that is to say large diameters in the range of μm, the centrifugal force prevents uniform coating. This is now possible because of the use of nanoscale particle sizes, in the range of in particular 1 to 50 nm.

### BRIEF DESCRIPTION OF THE DRAWINGS

The invention is to be explained in more detail below on the basis of several exemplary embodiments. In the drawing:

FIG. 1 shows an LED, in section;

FIG. 2 shows a representation of the principle of the shifting of chromaticity points in the CIE diagram (FIG. 2a), in particular in the case of a low-absorbing phosphor (FIG. 2b) and modified phosphor (FIG. 2c);

FIG. 3 shows a representation of the principle of reduced absorption of a modified phosphor;

FIG. 4 shows a representation of the principle of the shifted emission of a modified phosphor;

FIG. 5 shows a representation of the shifting of the chromaticity points in the case of low Ce concentration for YAG:Ce and in the case of the addition of Ga to Al in the YAG:Ce system;

FIG. 6 shows a representation of the principle of low absorption with regard to the emission of the primary radiation;

FIG. 7 shows a representation of the principle of the emission of a semiconductor phosphor.

### PREFERRED IMPLEMENTATION OF THE INVENTION

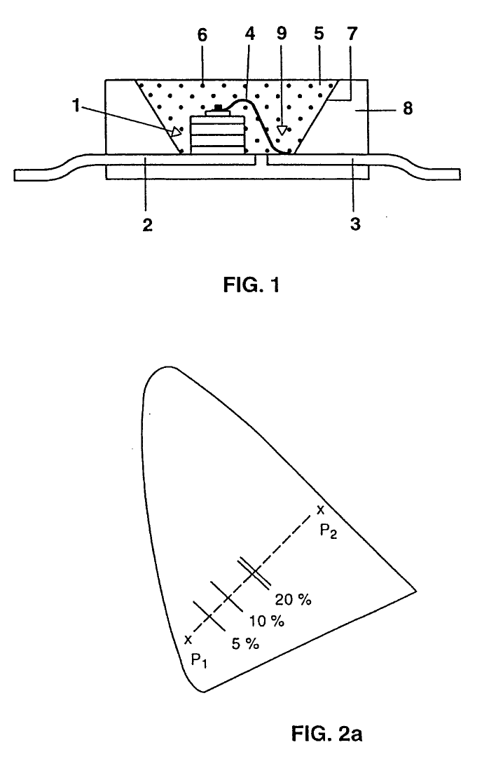

For use in a white LED, which operates according to the LUCOLED principle, together with an InGaN chip, a construction similar to that described in U.S. Pat. No. 5,998,925 is used for example. The construction of such a light source for white light is explicitly shown in FIG. 1. The primary light source is a semiconductor device (chip 1) of the InGaN type with a peak emission wavelength of 460 nm, with a first and second electrical terminal 2, 3 ending at the chip, which is embedded in an opaque basic housing 8 in the region of a recess 9. One of the terminals 3 is connected to the chip 1 via a bonding wire 4. The recess has a wall 7, which serves as a reflector for the blue primary radiation of the chip 1. The recess 9 is filled with a nonconductive encapsulating compound 5, which contains as main constituents a polymer, silicone or else epoxy casting resin (80 to 90% by weight) and phosphor pigments 6 (less than 15% by weight). Such a diode is operated at a voltage of typically 3 V. The voltage is provided to the terminals 2, 3 by a voltage source SP.

Suitable in particular as the photoluminescent nanophosphor for a primary blue emitting LED are YAG:Ce, in particular with a low Cer concentration of 0.1 to 0.6 below 1 mol %, and Y3(AlxGay)5O12:Ce, in particular with a relatively high Cer concentration of 1 to 5 mol %, where x+y=1 and y=preferably 0.1 to 0.5. Particularly suitable is 0.5, in particular the phosphor Y3(Al0.6Ga0.4)5O12:Ce.

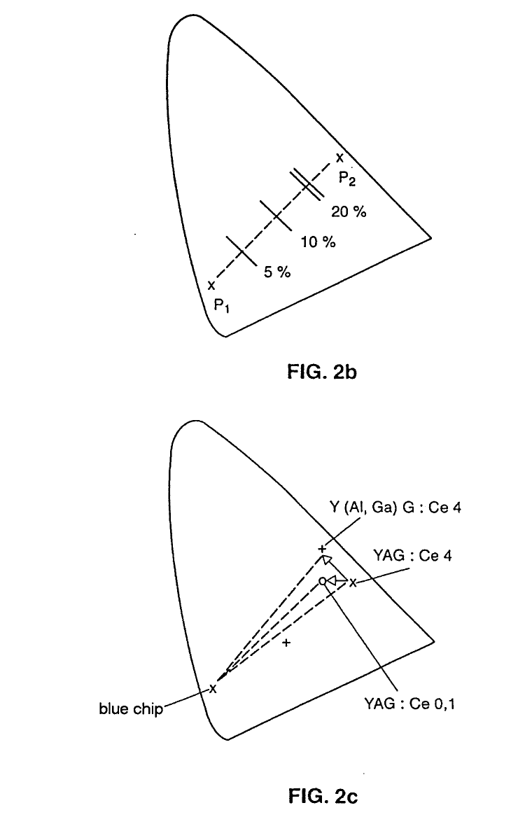

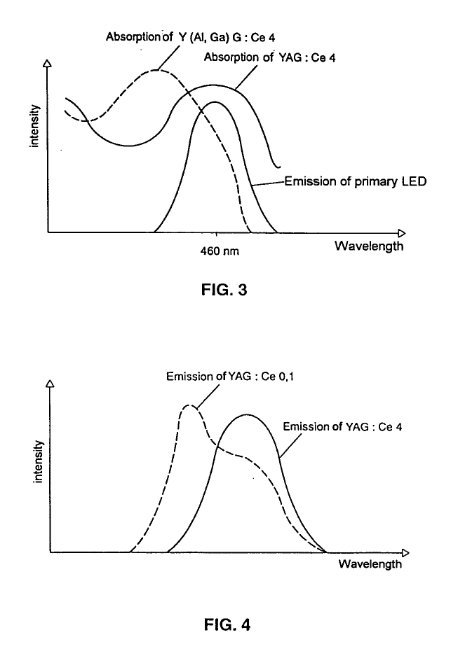

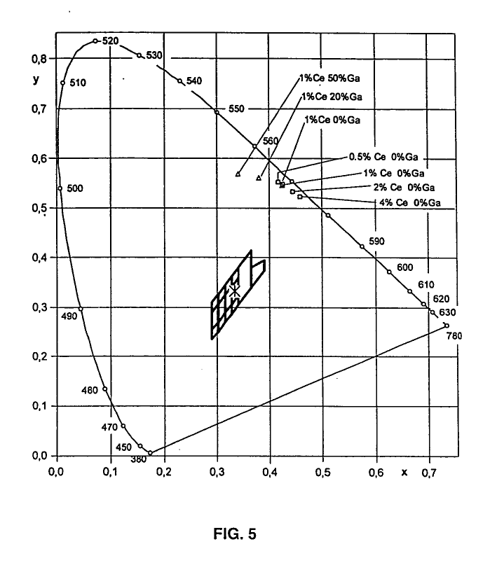

In the case of these phosphors, the chromaticity point is often much greener than that of the previously used YAG:Ce. The absorption of the Ga-containing garnet is shifted for example in the direction of short wavelength, see FIG. 3 as a principle. It may shift so far that the point A=50% in the absorption curve lies under the peak wavelength of 460 nm of the primary emission, see FIG. 2c as a diagram of the principle and the more detailed information specified in FIG. 5. This type of phosphor is used here as a single nanophosphor together with an InGaN chip. Its μm variant on the other hand cannot be used for LED applications.

A similar situation exists when using low concentrations of the activator. In the case of YAG:Ce with a low activator concentration (for example 0.1 to 0.5 mol % Ce as the proportion of the component Y) and similar systems, the chromaticity point of the emission of the phosphor lies much more in the green range than in the case of a high Cer concentration (2 to 4 mol %), see principle according to FIG. 2c; the shifting of the emission to shorter wavelengths is represented in principle in FIG. 4. This situation is likewise represented in detail in the shifting of the chromaticity points in FIG. 5. Here, too, the absorption curve shifts toward shorter wavelengths, so that with the given emission spectrum of the chip the absorption of the phosphor is reduced. This behavior, which can only be advantageously exploited when nanoscale phosphors are used, is observed in particular in the case of many garnets doped in particular with rare earths (above all Ce, Eu, Pr and/or Ce or Tb). Y, La, Lu, Gd, Tb come into consideration in particular for the component A, on the one hand, and Al, Ga and In for the component B as constituents of the host lattice A3B5012.

The mean particle size d50 of the nanophosphor is preferably approximately 5 to 10 nm. Such nanophosphors minimize the scattering of the exciting blue radiation. Consequently, the efficiency increases as a result of reduction of the scattering and reflection losses on the housing wall. Here, low-absorbing phosphors can be used in particular. In this case, the phosphor particles are homogeneously distributed over the resin suspension. No sedimentation occurs.

Suitable in particular as the phosphor for a UV emitting LED are the aforementioned RGB combinations of three nanophosphors, for example a combination of SCAP (blue), a Cu-doped ZnS:Cu or Sr4Al14O25:Eu (green) and Sr nitride or an oxysulfide (red).

Above all in the case of this variant (UV), the long absorption path now possible because of the use of nanophosphors has a particularly advantageous effect. The long path prevents UV radiation from leaving the zone of the conversion and consequently harming the surroundings, in particular the housing. Particularly preferred therefore is a layer thickness of the resin or encapsulating compound containing the phosphor that ensures that, advantageously, no more than 5% of the original UV radiation leave the conversion zone unhindered—that is to say at least 95% of the original UV radiation is absorbed or scattered. The extinction is consequently intended to be at least 80%, preferably at least 90%, particularly preferably at least 95% for a primary radiation of a peak wavelength which lies in the range of 330 to 410 nm. In the case of UV-LEDs, by contrast with a blue LED, no problem of a point light source occurs. Preferred ways in which this is realized are either RGB solutions or BY (blue-yellow) solutions.

One particular advantage of nanophosphors is simplified application to the chip. They are suitable for so-called on-chip coating. This specifically proceeds as follows:

Spin coating: a small amount of liquid is dripped onto a rotating wafer. The rotation causes formation of a uniform layer (standard method of applying photoresist in the semiconductor industry). When phosphor particles are used, segregation occurs because of the centrifugal forces. This is not the case with nanoparticles.

In the case of ink-jet methods, a uniform and structured application of nanophosphors is possible in suitable binders.

Nanophosphors can be stably kept in solution and are therefore also suitable for application methods by means of ink-jet, spin-coating or else photoresist technologies.

Semiconducting nanophosphors such as for example (Zn, Cd) (S, Se, Te) advantageously absorb directly above the band gap, with great absorption under all circumstances.

In general, rare-earth-doped nanophosphors can be synthesized by means of CVR. This novel process is compatible with known CVD processes. It represents an alternative coating method. In this case, no binder is necessary as a matrix.

In a particularly preferred exemplary embodiment, the mean particle size d50 of the phosphor is respectively chosen such that it corresponds to a minimum of the reflection of this phosphor, based on the peak wavelength of the primary radiation. In this sense, the LEDs and phosphors are consequently a coordinated system, it being necessary in the case of a number of phosphors for their particle size d50 to be chosen to differ. For a given peak wavelength of the LEDs, a mean diameter of the assigned phosphor that is as large as possible is advantageously chosen, because production is then easier.

Furthermore, systems in which a conventional phosphor component and a semiconductor component are used together are also possible. A particularly preferred exemplary embodiment is a UV-LED with RGB conversion, using an RGB combination, for red: Y2O2S:Eu+, for green (ZnS:Cu,Al or ZnS:Cu,Mn or ZnS:Cu), these phosphors being semiconductor components, and for blue (SCAP or ZnS:Ag), with SCAP being for example a conventional inorganic doped phosphor.

A preferred special encapsulating system for nanophosphors is silicone. This is so because silicones are particularly aging-stable encapsulating compounds for emitters in the near UV and blue spectral ranges.

A particularly preferred exemplary embodiment is a system in which the chip itself is suitably structured to receive nanophosphors. For this purpose, the chip may be etched on its surface, so that it has a porosity into which the nano materials can penetrate. The advantage of this solution is that the reflection losses can be reduced still further as a result.

Actual examples of phosphors which absorb the exciting radiation of a UV-LED with 380-410 nm primary emission only at the margin of the absorption edge, and consequently have low absorption, and so have not previously been able to be used for LED applications but can be used as nanophosphors, are sulfates, borates and apatites.

Another group of phosphors which absorb well, but the important aspect of which is the uniformity of the light radiation achieved by the nano configuration, are garnets, thiogallates and chlorosilicates.

In FIGS. 2a and 2b, the attainability of new chromaticity points for a phosphor with a low activator concentration is schematically illustrated. Concerned for example is an InGaN LED which emits blue (for example 460 nm peak emission), see chromaticity point P1, and which is combined in one instance with a conventional phosphor YAG:Ce (whose own theoretical chromaticity point is marked by P2) (FIG. 2a) and also with a nanophosphor YAG:Ce with the same Ce concentration (FIG. 2b). Both phosphors use 0.1 to 0.5 mol % Ce, and the proportion of the resin is chosen in each case to be between 5 and up to 20% by weight. The reduced scattering over a long path then has the effect that the resulting chromaticity point when a large amount of phosphor is admixed (10 and 20%) is much closer to the theoretical chromaticity point P2 of the YAG:Ce. In FIG. 2a, the short distance to the chromaticity point of the 20% admixture illustrates the only small usable chromaticity point range because of the high absorption (up to a maximum resin content of 20%) of the pm variant on the line joining the chromaticity point of the LED primary emission P1 and that of the phosphor P2. On the other hand, the much longer distance in FIG. 2b to the 20% admixture chromaticity point there illustrates the increased usable range when the nanophosphor is used. More detailed chromaticity points for YAG:Ce with different Cer concentrations are represented in FIG. 5 for pure YAG:Ce (without Ga, denoted there as 0% Ga) and with partial substitution of the Al by Ga (denoted there as 20% Ga and 50% Ga). A white region around the white point 0.333/0.333 is likewise represented. Such nanophosphors consequently allow the possibility of access to chromaticity points with x≧0.35 and/or y≧0.35, in particular also colored chromaticity points with x≧0.40 and/or y≧0.40.

In FIG. 2c it is shown as a diagram of the principle that the substitution of 40 mol % of the aluminum by Ga has the effect that the chromaticity point moves to the right in the CIE diagram, that is to say toward greener chromaticity points, while retaining the advantage of better attainability of the theoretical chromaticity point, in a way similar to that shown in the case of FIG. 2b.

A suitably chosen nano-YAG:Ce with a reduced activator content shows a consistently high quantum efficiency independently of the thickness of the encapsulating compound. This behavior makes completely new geometrical embodiments possible for the first time, such as for example extremely flat LED devices.

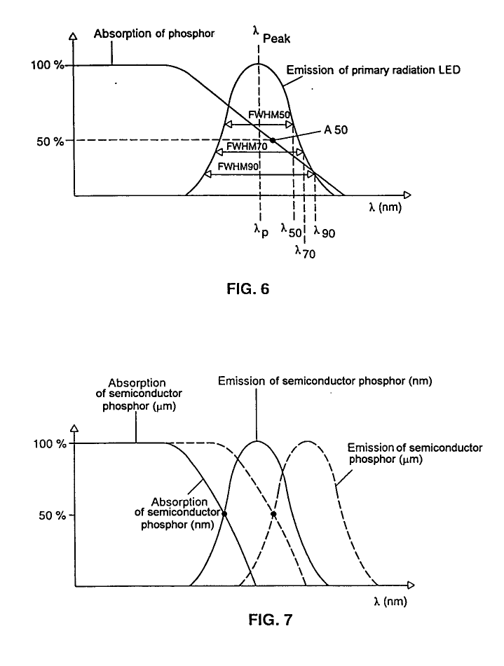

To be regarded as an important consequence of the above is that choice of the nanoscale particle size opens up a new class of phosphors for use in the case of LEDs, with which the absorption edge at which the absorption of the phosphor is only 50% of the maximum absorption, described by the A50 point, lies at a much shorter wavelength than the long-wave edge of the primary emission of the chip. For example, now phosphors with a high efficiency and an A50 point that lies below the long-wave threshold of an emission intensity of 10% of the peak emission λpeak can be used well, see FIG. 6. This long-wave edge λ90 of the primary emission, which belongs to the 90% width “FWHM 90” of the primary emission, generally lies about 10 to 15 nm (for example 475 nm) above the peak emission (for example at λp=460 nm). This usability is surprisingly even applicable in many cases when the point A50 lies below the wavelength belonging to the long-wave edge point “FWHM 70”, λ70, in particular even below the wavelength belonging to the long-wave edge point “FWHM 50”, λ50, see FIG. 6. Even a value of A50 below the wavelength of peak emission, λp, can now be used. This teaching is in complete contrast to the previous philosophy of best possible matching between primary emission and absorption curve of the converting phosphor, as presented in U.S. Pat. No. 5,998,925.

In a further preferred embodiment, the nanophosphor on the basis of semiconductors is provided with a coating which prevents agglomeration of the powder, as known per se, see introduction.

One particular advantage of nanophosphors is that they are easy to process, so that there is no longer a reliance on complicated casting resin systems, but instead rapid processing by means of printing, spraying or ink-jet can be used.

The smallness of the phosphor particles then has the result that abrasive effects are not a concern and clogging of fine nozzles does not occur. Consequently, process control is greatly simplified.

Phosphors with hard particles, such as for example garnets, restrict the choice of materials and methods for metering. In the case of garnets, which are introduced by means of spindle metering units, it has not been possible so far to use customary tool steels, but instead hard metal has been used for the spindle and guide. This restriction no longer applies when nanophosphor is used. A further simplification is obtained with respect to the choice of methods. For small amounts and structured application, ink-jet methods also come into consideration.

The production of nanophosphor particles is widely described in the literature. Customary methods are based on CVD, sol-gel techniques or precipitation.

The particular advantage of semiconductor phosphors such as CdSe is that the band gap can be set by the particle size. The principle is represented in FIG. 7. For a specific exciting peak wavelength, which is to be in as narrow a band as possible, preferred is a typical full width at half maximum of less than 20 nm, preferably 10 nm, it is the case here that the emission of the semiconductor phosphor moves toward shorter wavelengths as the particle diameter becomes smaller, since the absorption of the primary radiation by the semiconductor phosphor is likewise shifted toward shorter wavelengths, and at the same time the absorption and emission are linked to each other by a fixed relationship (50% rule).

In the case of semiconducting phosphors, it is preferred to use a white emitting overall system, comprising a blue emitting primary light source and a single yellow emitting phosphor. Alternatively, a blue-green primary light source is combined with a red phosphor. One example is an InGaN chip with a peak wavelength of 485 nm and a nanophosphor of the (Ca,Ba,Sr) nitride type, as described for example in EP 1 153 101.

Note: FW means full width, see FIG. 6. FWHM means full width at half maximum, that is FW50.

The conversion of the primary radiation of the chip into secondary radiation emitted by the phosphor is accompanied by a difference in the peak wavelength of the two radiations of at least 20 nm, typically at least 50 nm, frequently also at least 100 nm.

1. Luminescence-conversion LED, an LED chip emitting primary radiation with a peak wavelength in the range of 300 to 470 nm, this radiation being converted partly or completely into secondary longer-wave radiation by photoluminescence by at least one phosphor which is exposed to the primary radiation of the LED, wherein the conversion is achieved at least with the assistance of a phosphor of a mean particle size d50 that lies in the range of 1 to 50 nm, preferably 2 to 25 nm, which is referred to hereafter as a nanophosphor.

2. The LED as claimed in claim 1, wherein the phosphor is dispersed in an encapsulating compound which is exposed to the primary radiation, the encapsulating compound consisting of insulating material.

3. The LED as claimed in claim 1, wherein a blue emitting primary radiation of a peak wavelength of 420 to 470 nm is used, together with a secondary yellow emitting phosphor.

4. The LED as claimed in claim 1, wherein a UV emitting primary radiation of a peak wavelength of 330 to 410 nm is used, together with three secondary red, green and blue emitting phosphors.

5. The LED as claimed in claim 4, wherein the following phosphor system is used: for red: Y2O2S:Eu; and for green: ZnS: Cu,Al or ZnS:Cu,Mn or ZnS:Cu; and for blue SCAP or ZnS:Ag.

6. The LED as claimed in claim 1, wherein the phosphor is chosen such that it has only low absorption in the range of the peak wavelength of the primary radiation and is in particular a phosphor that is made to luminesce by an activator.

7. The LED as claimed in claim 6, wherein a nanophosphor is chosen such that an identical, but coarser-grained phosphor, which is referred to hereafter as a μm phosphor, exhibits at the peak wavelength of the LED chip a reflection of greater than 50% when a reflection measurement is carried out on a pressed powder tablet which consists of the μm phosphor and which is optically dense, that is to say has an angle-integrated transmission of <5%, coarse-grained meaning that the mean particle size d50 is greater than 1 μm, in particular d50 is ≦20 μm, preferably d50 is ≦10 μm.

8. The LED as claimed in claim 6, wherein the long-wave absorption edge of the nanophosphor, which is described by the point A50, lies under the long-wave edge of the primary emission, described by the long-wave point FW 90, preferably FW 70, particularly preferably by FW 50, extremely preferably by the peak wavelength itself.

9. The LED as claimed in claim 7, wherein a nanophosphor with an activator is used, chosen such that the concentration of the activator is low, to be precise reaches at most 75%, preferably 10 to 50%, of the concentration of the activator in the case of the identical μm phosphor, so that the given activator concentration of the μm phosphor is higher and serves as a reference corresponding to 100%, the μm phosphor being chosen such that it has high absorption in the range of the peak wavelength of the primary radiation, preferably more than 50%, in particular more than 70%, but an identical phosphor with low concentration of the activator has low absorption in the range of the peak wavelength of the primary radiation, preferably at most 30%, in particular at most 20%.

10. The LED as claimed in claim 1, wherein a single phosphor is used, comprising semiconducting nanoparticles, in particular CdSe.

11. The LED as claimed in claim 1, wherein the chip can be connected to a voltage source via electrically conductive terminals.

12. The LED as claimed in claim 11, wherein the voltage source provides a voltage of at most 5 V.

13. The LED as claimed in claim 9, wherein the nanophosphor is a garnet A3B5012 which is doped with a rare earth element D, the proportion of D being at most 0.9 mol % of A.

14. The production of LEDs with nanophosphors as claimed in claim 1, the phosphor being applied directly to the chip by means of CVR or CVD.

15. The production of LEDs with nanophosphors as claimed claim 1, the phosphor being applied to the chip by means of printing, spraying or ink-jet.

16. The use of nanophosphors with a mean particle size d50 of 1 to 50 nm as a conversion means in optical semiconductor devices of the LUCOLED type for the conversion of short-wave primary emitting radiation between 300 and 470 nm into longer-wave radiation, in particular into visible radiation in the range of 430 to 750 nm.
